(19) United States
(12) Patent Application Publication
(10) Pub. No.: US 2005/0174642 A1
(43) Pub. Date: Aug. 11, 2005

(54) Optical element

(75) Inventors: Takashi Tokunaga, Tokyo (JP); Yoshio Fujii, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Tokyo (JP)

(21) Appl. No.: 10/637,698

(22) Filed: Aug. 11, 2003

(30) Foreign Application Priority Data
Mar. 7, 2003 (JP) 2003-061538

(51) Int. Cl. G02B 5/30

(52) U.S. Cl. 359/495; 359/494

(57) ABSTRACT

An optical element which polarizes light, including: a substrate having a major surface with a first axis, the major surface including concave and convex portions arranged periodically in the direction of the first axis; and a laminated structure disposed on the major surface, in which first and second dielectric layers having different refractive indexes are stacked, one atop the other. The laminated structure includes a low-refraction area that is periodic in the direction of the first axis. The refractive index of the low-refraction area is smaller than the first or second dielectric layer which is adjacent to the low-refraction area.

### CROSS-REFERENCE TO RELATED APPLICATION

Related patent application is commonly assigned Japanese Patent Application No. 2003-61538 filed on Mar. 7, 2003, which is incorporated by reference into the present patent application.

### BACKGROUND OF THE INVENTION

1. Field of the Invention

The present invention relates to an optical element which polarizes transmitted light and reflected light and a method of manufacturing the same.

2. Description of the Related Art

A polarizing element is an optical element which is capable of transmitting or reflecting only a desired linear polarized light component. For example, such a polarizing element has been proposed which uses a two-dimensional periodic structure in which dielectric material layers having different refractive indexes from each other are stacked one atop the other in wavelength or shorter periods, namely, photonic crystals. When the periods of dielectric material layers are set appropriately, so-called photonic crystals exhibit a photonic band gap (PBG) which does not permit propagation of light. Using the PBG, it is possible to reflect one of mutually orthogonal polarized wave components having different propagation characteristics from each other, while transmitting the other one of the polarized wave components.

One example of a polarizing element using photonic crystals is a polarizing element in which two or more types of film-like materials having approximately periodic one-dimensional concave and convex portions are stacked one atop the other approximately periodically. To be specific, this is a multi-layer structure in which on a substrate which includes a periodic groove, an SiO₂ film which is a transparent medium whose refractive index is low and an Si layer which is a transparent medium whose refractive index is high are alternately stacked one atop the other (JP, 3288976, B).

Such a polarizing element is fabricated by alternately forming an SiO₂ layer and a Si layer on a substrate which seats periodic groove-like concave and convex portions while maintaining the shapes of the concave and convex portions, using a bias sputtering method. A bias sputtering method requires to execute deposition and etching at the same time, and was proposed as an automatic cloning method.

Also proposed as a similar polarizing element using photonic crystals is a polarizing element in which a groove is formed by RIE in a multi-layer film of repeatedly stacked Si/SiO₂ and periodically repetitive structures are accordingly formed (Chuan C. Cheng et al., “New fabrication techniques for high quality photonic crystals” J. Vac. Sci. Technol. B 15(6), pp. 2764-2767 (1997)).

The first polarizing element above demands to control so as to achieve appropriate deposition and etching during automatic cloning, and therefore, it is difficult to set up conditions for bias sputtering. Further, there is a problem that a general-purpose sputtering apparatus cannot be used.

Meanwhile, with respect to the second polarizing element, it is extremely difficult to form a groove in periods which are equal to or shorter than the wavelength of light in a laminated structure in which the different materials of the Si layer and the SiO₂ layer are alternately stacked one atop the other, and since this requires to use less laminations, a problem that a quenching rate becomes small arises.

### SUMMARY OF THE INVENTION

The present invention aims at providing a laminated-type optical element which allows easy industrial fabrication and a method of manufacturing the same.

The present invention is directed to an optical element which polarizes light, including a substrate having a major surface with a first axis, the major surface being formed so as to include concave and convex portions arranged periodically in the direction of the first axis. The optical element further includes a laminated structure disposed on the major surface, in which a first dielectric layer and a second dielectric layer whose refractive index is different from that of the first dielectric layer are stacked one atop the other. The laminated structure includes a low-refraction area which is periodically disposed in the direction of said first axis. The refractive index of the low-refraction area is smaller than that of the first dielectric layer or the second dielectric layer which is adjacent to the low-refraction area.

The present invention is directed also to a method of manufacturing an optical element which polarizes light, including: a step of preparing a substrate having a major surface with a first axis; a step of forming concave and convex portions on the major surface arranged periodically in the direction of the first axis; and a stacking step of alternately depositing a first dielectric layer and a second dielectric layer whose refractive index is different from that of the first dielectric layer on the major surface. The stacking step is a step at which a corpuscular ray which is to impinge upon the major surface is allowed to impinge from a direction which is inclined with respect to the vertical direction to the major surface in such a manner that the convex portions will partially block the corpuscular ray. And thereby, a low-refraction area, whose refractive index is lower than that of the first dielectric layer or the second dielectric layer which is adjacent to the same, is formed within the first dielectric layer and the second dielectric layer.

### BRIEF DESCRIPTION OF THE DRAWINGS

FIG. 1 is a cross sectional view of the optical element according to the first preferred embodiment;

FIG. 2 is a cross sectional view of the silicon substrate which is used in the optical element according to the first preferred embodiment;

FIG. 3 a diagram showing a relationship between the wavelength and the transmittance in the optical element according to the first preferred embodiment;

FIG. 4 is a cross sectional view of the optical element according to the second preferred embodiment; and

FIG. 5 is a cross sectional view of the silicon substrate which is used in the optical element according to the second preferred embodiment.

### DETAILED DESCRIPTION OF THE PREFERRED EMBODIMENTS

First Preferred Embodiment

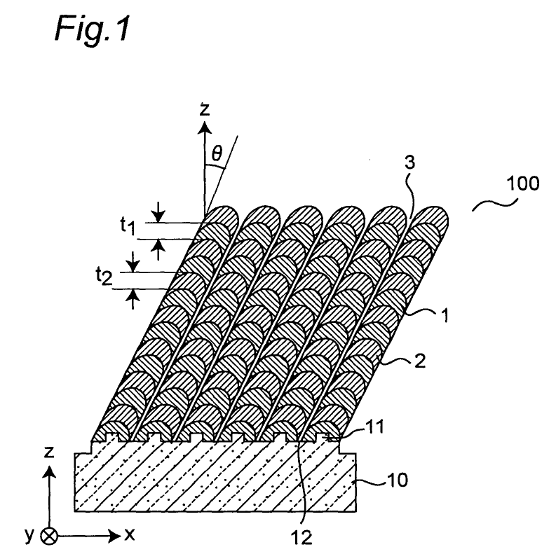

FIG. 1 is a cross sectional view of a laminated-type optical element according to a first preferred embodiment of the present invention, generally denoted at 100. In FIG. 1, the x-axis, the y-axis and the z-axis are three axes which are orthogonal to each other, the x-axis is an axis which is parallel to a major surface of a silicon substrate 10, and the z-axis is an axis which is perpendicular to a major surface of the silicon substrate 10.

The optical element 100 includes the silicon substrate 10. Convexes 11 are disposed in predetermined periods along the direction of the x-axis, on the major surface of the silicon substrate 10. The convexes 11 extend as stripes along the direction of the y-axis.

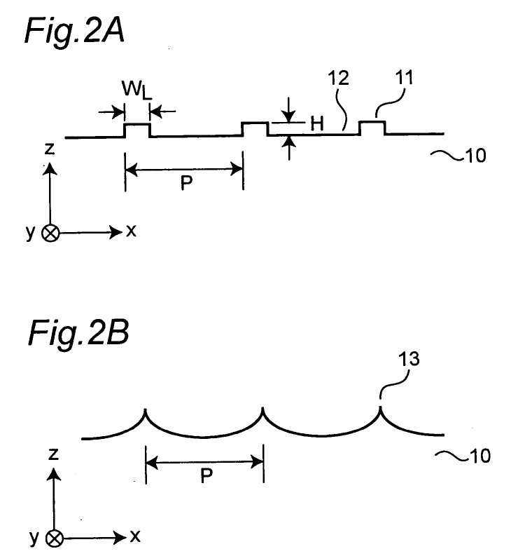

FIG. 2A is a cross sectional view of a section in the vicinity of the major surface of the silicon substrate 10, taken along the direction of the x-axis. The major surface of the silicon substrate 10 is etched and the etched portions become concaves 12, thereby leaving the convexes 11 periodically. The convexes 11 appear in periods along the direction of the x-axis which are shorter than the wavelength of light which is polarizes by the optical element 100. The periods (pitches) P are 0.4 μm in this example. The width W_{L} of the convexes 11 is 0.08 μm, and the height H of the convexes 11 is 0.05 μm.

On the silicon substrate 10, silicon layers 1 which are transparent dielectric layers and silicon oxide layers 2 which similarly are transparent dielectric layers are alternately stacked one atop the other. The refractive index of the silicon layers 1 is higher than that of the silicon oxide layers 2. The film thickness t₁ and t₂ along the direction of the z-axis of the silicon layers 1 and the silicon oxide layers 2 are 0.11 μm and 0.16 μm, respectively. The silicon layers 1 and the silicon oxide layers 2 are formed seven layers each, in total fourteen layers. The optical element 100 thus have a structure that layers having different refractive indexes from each other are stacked one atop the other in the direction of the z-axis.

The film thickness of only the top-most silicon oxide layer 2 is 0.35 μm. This is to prevent a variation in transmission characteristic which is called a “ripple.” Further, a back surface of the silicon substrate 10 is coated with a non-reflection film (not shown) such as SiON for example, which prevents reflection of incident light at the back surface.

In the optical element 100, since the silicon layers 1 and the silicon oxide layers 2 are stacked on the convexes 11, cavities 3 are created on the concaves 12. The cavities 3 are created as they are inclined at an angle θ with respect to the direction of the z-axis. As described later, the angle θ is dependent upon the angle of incidence of sputter particles which are used to form the silicon layers 1 and the silicon oxide layers 2.

As shown in FIG. 1, the cavities 3 are created in predetermined periods in the direction of the x-axis. Further, the refractive index of the cavities 3 (the refractive index of air) is smaller than that of any one of the silicon layers 1 and the silicon oxide layers 2 which are formed on the both sides of the cavities 3. The optical element 100 has a structure that the cavities 3 having a low refractive index which are disposed at the angle θ with respect to the direction of the z-axis are located in the predetermined periods in the direction of the x-axis.

In this fashion, in the optical element 100, the major surface of the silicon substrate 10 is structured as stripes which run in the direction of the y-axis, and the high refractive index layers and the low refractive index layers are stacked one atop the other alternately in the predetermined periods. The optical element 100 therefore exhibits a polarization characteristic with respect to light which is along the direction of the z-axis.

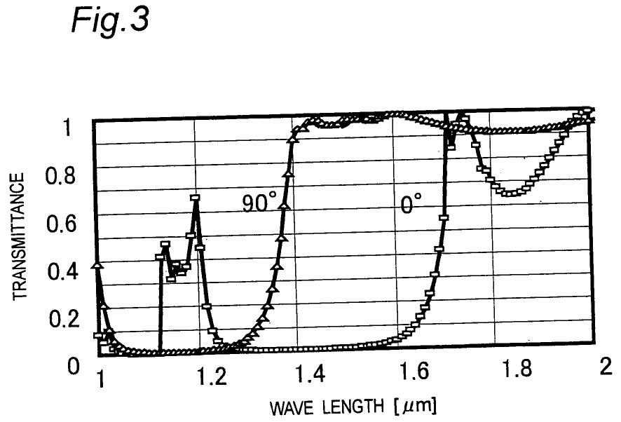

FIG. 3 shows a transmission characteristic of the optical element 100 in a condition that light is incident from the direction of the z-axis. The transmission characteristic was measured using a spectrophotometer. In FIG. 3, the horizontal and vertical axes show the wavelength and transmittance of transmitted light, respectively. As FIG. 3 shows, when the wavelength remains in the range from about 1.4 μm to about 1.6 μm, transmittance of light, whose polarization directions are different 90 degrees from each other, are largely different from each other. Hence, use of the optical element 100 allows to obtain an excellent polarization characteristic with respect to light whose wavelength is from about 1.4 μm to about 1.6 μm.

It is preferable to set the periods P, the width W_{L} and the height H of the convexes 11 as follows in FIG. 2A, to thereby obtain the optical element 100 which exhibits such an excellent polarization characteristic.
P<λ
0<W_{L}≦k·P
0<H≦k·P
where the symbol λ denotes the wavelength of light and the symbol k denotes a coefficient. While the value k is 0.5 in this embodiment, the value k is preferably 0.3. Under the condition of k>0.5, the cavities 3 disappear as the number of the stacked layers increases, and the adjacent dielectric films on the convexes 11 become contiguous to each other and turn into a film which is continuous along the direction of the x-axis. Although such a structure exhibits a polarization characteristic, a polarization-dependent wavelength shift becomes small, and a quenching rate decreases.

In the optical element 100, with the periods (P) in the direction of the x-axis and the periods in the direction of the z-axis (film thickness t₁, t₂) controlled, a wavelength range which causes a photonic band gap (PBG) can be freely changed with respect to a TE wave and a TM wave contained in light along the direction of the z-axis.

A method of manufacturing the optical element 100 will now be briefly described. When the manufacturing method according to this embodiment is used, the silicon substrate 10 having a major surface is prepared. The silicon substrate 10 may be replaced with other semiconductor substrate of as GaAs or the like, a glass substrate of quartz, Pyrex (registered trademark) or the like, a substrate of a polymer material, etc.

The major surface of the silicon substrate 10 is then etched, thereby forming the stripe-shaped convexes 11 which are located in the predetermined periods.

At the step of forming the convexes 11, first, a resist pattern shaped as stripes which run in the direction of the y-axis at pitches of 0.4 μm is formed on the silicon substrate 10 at a photolithography step using EB exposure. Following this, through ECR etching using the resist pattern as an etching mask, a pattern as that shown in FIG. 2A is formed.

Alternatively, isotropic etching such as wet etching may be executed after turning the striped pattern into a thermally oxidized film or a mask layer on the silicon substrate through ECR etching which uses the resist pattern as an etching mask while using the silicon substrate seating a thermally oxidized film or the silicon substrate on which a mask layer has been formed in advance, to thereby form convexes 13 as those shown in FIG. 2B.

Next, by a sputtering method, silicon particles and silicon oxide particles are deposited alternately on the major surface of the silicon substrate 10. The silicon layers 1 are formed by DC sputtering which uses silicon as a target, while the silicon oxide layers 2 are formed by RF sputtering which uses silicon oxide as a target.

During the sputtering, the direction of incidence of the sputter particles is the direction which is inclined at the predetermined angle with respect to the direction of the z-axis (vertical direction). To be more specific, the silicon substrate 10 is positioned approximately perpendicular to a substrate holder of a sputtering apparatus to thereby ensure that the sputter particles impinge at an angle upon the major surface of the silicon substrate 10.

As a result, the convexes 11 block some of the sputter particle thus impinging upon the major surface of the silicon substrate 10 (shadow effect), and the dielectric films accordingly fail to deposit on a part of the silicon substrate 10 and thus become the cavities 3.

Alternatively, a blocking plate (not shown) may be disposed between the sputter targets and the silicon substrate 10 and sputter particle components impinging upon the silicon substrate 10 from the direction of the z-axis (vertical direction) may be blocked. This prevents the adjacent dielectric layers from linking with each other.

As the silicon particles and the silicon oxide particles are supplied alternately, in the direction of incidence of these particles, that is, in the direction which is inclined with respect to the z-axis, the silicon layers 1 and the silicon oxide layers 2 are deposited. Further, during this, the cavities 3 are formed which run also in the direction which is inclined at the angle θ with respect to the z-axis.

Although silicon and silicon oxide are used as the materials of the dielectric layers which are formed on the convexes 11 in this embodiment, other materials may be used instead which are transparent to the wavelength which is used in the optical element 100. For example, semiconductor materials such as germanium and GaAs, oxides and nitrides such as TiO₂, Ta₂O₅, SiN or the like may be used.

Through these steps, the optical element 100 is completed.

While the cavities 3 are formed between the adjacent dielectric layers (the silicon layers 1, the silicon oxide layers 2) in the optical element 100, when the angle of incidence of the sputter particles is appropriately selected, dielectric layers whose density is lower than those of the silicon layers 1 and the silicon oxide layers 2 can be formed instead of the cavities 3. In this structure, since the refractive index of the low density dielectric layers are also smaller than the refractive indexes of the silicon layers 1 and the silicon oxide layers 2, a similar effect to that obtained where the cavities 3 are formed is obtained.

In this manner, an optical element which exhibits an excellent polarization characteristic is obtained according to this embodiment.

Further, it is possible to fabricate a highly accurate optical element by a simple method as compared to conventional methods. In addition, it is possible to fabricate the optical element, using a general-purpose manufacturing apparatus. This realizes inexpensive manufacturing of optical elements at a high yield.

Second Preferred Embodiment

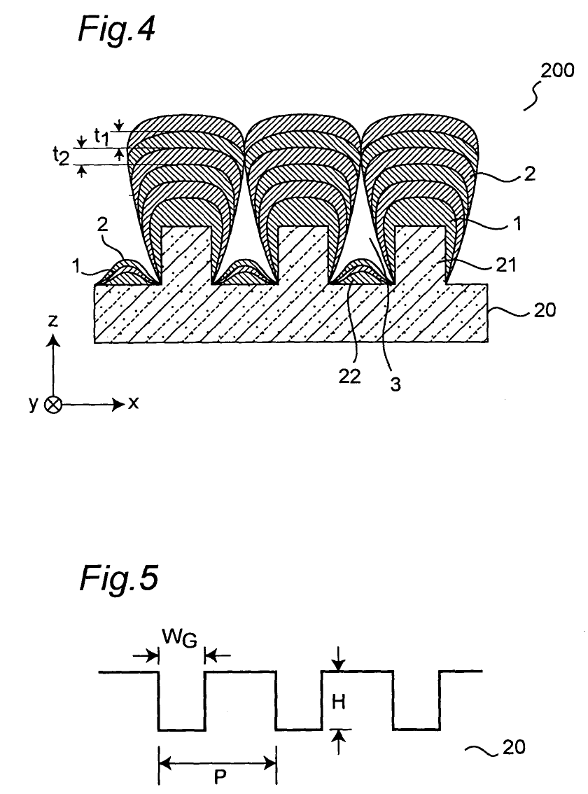

FIG. 4 is a cross sectional view of a laminated-type optical element according to a second preferred embodiment of the present invention, generally denoted at 200. In FIG. 4, portions which are the same as or correspond to those shown in FIG. 1 are denoted at the same reference symbols, and the coordinate axes are also the same as those in FIG. 1.

In the optical element 200, although a silicon substrate 20 is used which includes stripe-shaped concaves and convexes on a major surface as in the optical element 100 described above, the aspect ratios of the convexes 21 and the concaves 22 are higher than those in the optical element 100. The silicon layers 1 and the silicon oxide layers 2 are stacked three layers each, one atop the other on the convexes 21 approximately the direction of the z-axis.

In FIG. 4, the periods (pitches) P of the stripe-like convexes 21 are 1.4 μm. The width W_{G} of the convexes 21 is 0.8 μm, and the height H of the convexes 21 is 1.0 μm.

The film thickness t₁ and t₂ of the silicon layers 1 and the silicon oxide layers 2 along the direction of the z-axis are 0.26 μm and 0.11 μm, respectively. Since the film thickness are set as such, a polarizing mirror used at the wavelength of 1.55 μm can be formed.

To prevent a variation in transmission characteristic which is called a “ripple,” the film thickness of only the top-most silicon oxide layer 2 is 0.35 μm.

While there are the cavities 3 on the concaves 22, as the number of the stacked layers increases, the widths of the silicon layers 1 and the silicon oxide layers 2 stacked on the convexes 21 become wider.

With the optical element 200, it is possible to obtain an excellent polarization characteristic.

A method of manufacturing the optical element 200 will now be briefly described. According to this manufacturing method, first, the silicon substrate 20 which includes a major surface is prepared. As in the first preferred embodiment, the silicon substrate 20 may be replaced with a semiconductor substrate, a glass substrate or the like.

The major surface of the silicon substrate 20 is then ECR-etched, whereby the stripe-shaped convexes 21 as those shown in FIG. 5 are formed in predetermined periods.

Next, using a sputtering method, the silicon particles and the silicon oxide particles are deposited alternately on the major surface of the silicon substrate 20. The silicon layers 1 are formed by DC sputtering which uses silicon as a target, while the silicon oxide layers 2 are formed by RF sputtering which uses silicon oxide as a target. However, unlike in the first preferred embodiment, the direction of incidence of the sputter particles needs not be a direction which is inclined at a particular angle, but may include such an inclined direction of incidence in which the shadow effect (inclined incident component) is obtained.

Since the aspect ratio (height/width) of the concaves 22 in particular is large in the silicon substrate 20, the convexes 21 block some of the sputter particle thus impinging upon the major surface of the silicon substrate 20 (shadow effect), and the volumes of the silicon layers 1 and the silicon oxide layers 2 deposited within the concaves 22 decrease. In consequence, as shown in FIG. 4, the cavities 3 are formed on the concaves 22.

As the number of the stacked layers increases, the widths of the silicon layers 1 and the silicon oxide layers 2 deposited on the convexes 21 become gradually wider in the direction of the x-axis. However, since there are the cavities 3 formed on the concaves 22 in the optical element 200, the optical element 200 can exhibit a polarization characteristic along the direction of the z-axis.

In order to form the cavities 3 utilizing the shadow effect in this fashion, it is necessary that the width W_{G} and height H of the concaves 22 satisfy the following relationship:
0.1W_{G}≦H≦10W_{G}

Further, in order to obtain an excellent polarization characteristic in the direction of the z-axis, it is preferable that the periods (pitches) of the convexes 21 (or the concaves 22) and the wavelength used μ satisfy the following relationship:
P≦λ

Alternatively, as in the first preferred embodiment, the materials of the dielectric layers formed on the convexes 21 may be other materials which are transparent to the wavelength which is used in the optical element 200.

Further, although there are the cavities 3 on the concaves 22 in the optical element 200, dielectric layers whose density is lower than those of the silicon layers 1 and the silicon oxide layers 2 may be formed.

Through these steps, the optical element 200 shown in FIG. 4 is completed.

As described above, according to the second preferred embodiment, it is possible to obtain an optical element which exhibits an excellent polarization characteristic as in the first preferred embodiment. Further, it is possible to fabricate a highly accurate optical element by a simpler method than conventional methods. In addition, it is possible to fabricate an optical element using only a general-purpose manufacturing apparatus.

As is clear from the foregoing, it is possible to provide an optical element which is inexpensive, suitable to high-yield production and exhibits an excellent polarization characteristic, according to the present invention.

1-12. (canceled)

13. An optical element which polarizes light, the optical element comprising:
a substrate having a major surface with first and second orthogonal axes, the substrate having, on the major surface, concave and convex portions arranged periodically along the first axis, the concave and convex portions extending along the second axis; and
a laminated structure disposed on the major surface, enveloping the convex portions of the substrate and having regions free of the laminated structure located between adjacent pairs of the convex portions of the substrate, the laminated structure including first and second dielectric layers, alternatingly arranged and having refractive indexes, different from each other, wherein
the regions free of the laminated structure comprise low-refraction areas periodically arranged along the first axis, the refractive index of the low-refraction areas being smaller than the refractive index of the one of the first dielectric layer and the second dielectric layer which is adjacent to the low-refraction areas,
a portion of the major surface of the substrate is exposed between respective portions of the laminated structure at each of the low-refraction areas, and
each of the portions of the laminated structure has a surface, where the portion of the laminated structure contacts the major surface of the substrate, that is inclined with respect to a direction perpendicular to the major surface of the substrate.

14. The optical element according to claim 13, wherein surfaces of the portions of the laminated structure confining each low-refraction area are inclined in the same direction with respect to the direction perpendicular to the major surface of the substrate.

15. The optical element according to claim 13, wherein the convex portions are arranged periodically at a pitch, each of the convex portions has a width and a height, and the height and the width are both less than one-half of the pitch.

16-21. (canceled)
